(19) United States
(12) Patent Application Publication
(10) Pub. No.: US 2025/0224799 A1
(43) Pub. Date: Jul. 10, 2025

(54) VIDEO OUTPUT METHOD, VIDEO OUTPUT SYSTEM, AND RECORDING MEDIUM

(71) Applicant: Panasonic Intellectual Property Management Co., Ltd., Osaka (JP)

(72) Inventors: Kotaro SAKATA, Osaka (JP); Tetsuji Fuchikami, Osaka (JP)

(21) Appl. No.: 19/089,332

(22) Filed: Mar. 25, 2025

Related U.S. Application Data
(63) Continuation of application No. PCT/JP2023/022731, filed on Jun. 20, 2023.

(30) Foreign Application Priority Data
Oct. 19, 2022 (JP) 2022-167312

(51) Int. Cl. G06F 3/01; G06T 11/00; G08B 21/18

(52) U.S. Cl. CPC G06F 3/011; G06T 11/00; G06T 2210/04; G08B 21/18

(57) ABSTRACT

A video output method produces, in an augmented reality space provided by augmenting a real space, a display about one space in a facility including a plurality of spaces in the real space, and includes: acquiring status information indicating a status of each of the plurality of spaces; identifying, among the plurality of spaces in the real space, a first space where a user is currently present; determining, based on the status information of each of the plurality of spaces, as a second space to which the first space is to be coupled, a space that is currently in a predetermined status among the plurality of spaces in the real space; and outputting presentation information for presenting, to the user, via a cross reality (XR) device worn by the user, a video in which the second space determined is coupled to the first space in the augmented reality space.

### CROSS REFERENCE TO RELATED APPLICATIONS

This is a continuation application of PCT International Application No. PCT/JP2023/022731 filed on Jun. 20, 2023, designating the United States of America, which is based on and claims priority of Japanese Patent Application No. 2022-167312 filed on Oct. 19, 2022. The entire disclosures of the above-identified applications, including the specifications, drawings and claims are incorporated herein by reference in their entirety.

### FIELD

The present disclosure relates to a video output method, a video output system, and a recording medium.

### BACKGROUND

Conventionally, a multimedia communication system has been utilized which exchanges data such as sound and video between a plurality of communication devices in order to communicate the states of two geographically distant locations with video and sound. For example, Patent literature (PTL) 1 discloses a multimedia communication system which can provide a sense as if a plurality of geographically distant spaces exist adjacent to each other.

### CITATION LIST

### Patent Literature

PTL 1: Japanese Unexamined Patent Application Publication No. 2004-56161

### SUMMARY

### Technical Problem

Incidentally, a user may want to check the state of a space in a facility where the space is in a predetermined status. In such a case, it is desirable for the user to be able to easily check the state of the space in the predetermined status. However, PTL 1 does not discloses a technique which allows a user to easily check the state of a space in a predetermined status.

Hence, the present disclosure provides a video output method, a video output system, and a recording medium which allow a user to easily check the state of a space in a predetermined status.

### Solution to Problem

A video output method according to an aspect of the present disclosure is a video output method for producing, in an augmented reality space provided by augmenting a real space, a display about one space in a facility including a plurality of spaces in the real space, and the video output method includes: acquiring status information indicating a status of each of the plurality of spaces; identifying, among the plurality of spaces in the real space, a first space in which a user is currently present; determining, based on the status information of each of the plurality of spaces, as a second space to which the first space is to be coupled, a space that is currently in a predetermined status among the plurality of spaces in the real space; and outputting presentation information for presenting, to the user, via a cross reality (XR) device worn by the user, a video in which the second space determined is coupled to the first space in the augmented reality space.

A video output system according to an aspect of the present disclosure is a video output system for producing, in an augmented reality space provided by augmenting a real space, a display about one space in a facility including a plurality of spaces in the real space, and the video output system includes: an acquirer that acquires status information indicating a status of each of the plurality of spaces; an identifier that identifies, among the plurality of spaces in the real space, a first space in which a user is currently present; a determiner that determines, based on the status information of each of the plurality of spaces, as a second space to which the first space is to be coupled, a space that is currently in a predetermined status among the plurality of spaces in the real space; and an outputter that outputs presentation information for presenting, to the user, via a cross reality (XR) device worn by the user, a video in which the second space determined is coupled to the first space in the augmented reality space.

A recording medium according to an aspect of the present disclosure is a non-transitory computer-readable recording medium having recorded thereon a program for causing a computer to execute the video output method described above.

### Advantageous Effects

According to an aspect of the present disclosure, it is possible to realize a video output method and the like which allow a user to easily check the state of a space in a predetermined status.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a diagram showing an outline of a room layout rearranging system in an embodiment.

FIG. 2 is a block diagram showing the functional configuration of a server device in the embodiment.

FIG. 3A is a diagram showing a first example of a predetermined status in the embodiment.

FIG. 3B is a diagram showing a second example of the predetermined status in the embodiment.

FIG. 3C is a diagram showing a third example of the predetermined status in the embodiment.

FIG. 4 is a flowchart showing the operation of the server device in the embodiment.

FIG. 5 is a diagram showing a room layout before being rearranged in the embodiment.

FIG. 6 is a flowchart showing details of an operation in step S40 shown in FIG. 4.

FIG. 7 is a diagram showing the room layout after being rearranged in the embodiment.

### DESCRIPTION OF EMBODIMENTS

A video output method according to an aspect of the present disclosure is a video output method for producing, in an augmented reality space provided by augmenting a real space, a display about one space in a facility including a plurality of spaces in the real space, and the video output method includes: acquiring status information indicating a status of each of the plurality of spaces; identifying, among the plurality of spaces in the real space, a first space in which a user is currently present; determining, based on the status information of each of the plurality of spaces, as a second space to which the first space is to be coupled, a space that is currently in a predetermined status among the plurality of spaces in the real space; and outputting presentation information for presenting, to the user, via a cross reality (XR) device worn by the user, a video in which the second space determined is coupled to the first space in the augmented reality space.

In this way, the user can check the state of the second space via the XR device while being present in the first space, that is, without moving. The user uses the XR device worn by the user U to be able to check the state of the second space from any space. Hence, in the video output method according to the aspect of the present disclosure, the user is allowed to easily check the state of the space in the predetermined status.

For example, the status information may include information indicating an operation status of a device provided in a space, and the predetermined status may include a predetermined operation status of the device.

In this way, the user is allowed to easily check the state of the space where the device is in the predetermined operation status.

For example, the predetermined operation status may include completion of an operation performed by the device.

In this way, the user is allowed to easily check the state of the space where the operation performed by the device is completed.

For example, the predetermined operation status may include occurrence of an anomaly in the device.

In this way, the user is allowed to easily check the state of the space where the anomaly is occurring in the device.

For example, the video output method may further include: inquiring of the user whether to couple the second space to the first space in the augmented reality space, and the presentation information may be output when an instruction to couple the second space to the first space is acquired from the user.

In this way, the user can select whether the first space and the second space are coupled, and thus the user is allowed to easily check the state of the space where the device is in the predetermined operation status as necessary.

For example, the status information may include sensing data of a sensor provided in a space, whether a predetermined anomaly occurs in the space may be determined based on the sensing data, and the predetermined status may include the occurrence of the predetermined anomaly in the space.

In this way, the user is allowed to easily check the state of the space where the predetermined anomaly is occurring.

For example, the predetermined anomaly may include at least one anomaly of heat, smoke, sound, or odor in the space.

In this way, the user is allowed to easily check the state of the space where at least one anomaly of heat, smoke, sound, or odor is occurring.

For example, the presentation information may include information for forcibly presenting the video to the user via the XR device worn by the user.

In this way, the user is allowed to forcibly check the occurrence of the predetermined anomaly, and thus the user is allowed to easily check the dangerous status of the space.

For example, the video output method may further include: virtually rearranging the second space determined adjacent to the first space in room layout information indicating a room layout of the plurality of spaces in the facility, and the presentation information may include information for superimposing a video obtained by capturing the second space on the first space and presenting the video superimposed on the first space via the XR device when the user views, in the real space, a side of the second space virtually rearranged.

In this way, no matter where the user is in the facility, the video of the second space can be presented by being superimposed on the first space, and thus the user is allowed to easily check the state of a different space in the facility.

A video output system according to an aspect of the present disclosure is a video output system for producing, in an augmented reality space provided by augmenting a real space, a display about one space in a facility including a plurality of spaces in the real space, and the video output system includes: an acquirer that acquires status information indicating a status of each of the plurality of spaces; an identifier that identifies, among the plurality of spaces in the real space, a first space in which a user is currently present; a determiner that determines, based on the status information of each of the plurality of spaces, as a second space to which the first space is to be coupled, a space that is currently in a predetermined status among the plurality of spaces in the real space; and an outputter that outputs presentation information for presenting, to the user, via a cross reality (XR) device worn by the user, a video in which the second space determined is coupled to the first space in the augmented reality space. A recording medium according to an aspect of the present disclosure is a non-transitory computer-readable recording medium having recorded thereon a program for causing a computer to execute the video output method described above.

In this way, the same effects as in the video output method are achieved.

These general and specific aspects may be implemented using a system, a method, an integrated circuit, a computer program, or a non-transitory computer-readable recording medium such as a CD-ROM, or any combination of systems, methods, integrated circuits, computer programs, or recording media. A program may be previously stored in a recording medium, or may be supplied to the recording medium via a wide area communication network including the Internet and the like.

Embodiments will be specifically described below with reference to drawings.

Each of the embodiments described below indicates a general or specific example. Numerical values, constituent elements, the arrangement and connection of the constituent elements, steps, the order of the steps, and the like shown in the following embodiments are examples, and are not intended to limit the present disclosure. Among the constituent elements in the following embodiments, constituent elements which are not recited in the independent claims are described as optional constituent elements.

The drawings each are schematic diagrams, and are not exactly shown. Hence, for example, scales and the like are not necessarily the same in the drawings. In the drawings, substantially the same configurations are identified with the same reference signs, and repeated description is omitted or simplified.

In the present specification, numerical values and the ranges of numerical values are expressions which not only indicate exact meanings but also indicate substantially equivalent ranges such as a range including about a several percent difference (or about a 10 percent difference).

In the present specification, unless otherwise specified, ordinal numbers such as “first” and “second” do not mean the number or order of constituent elements but are used to avoid confusion of similar constituent elements and to distinguish between the similar constituent elements.

### Embodiment

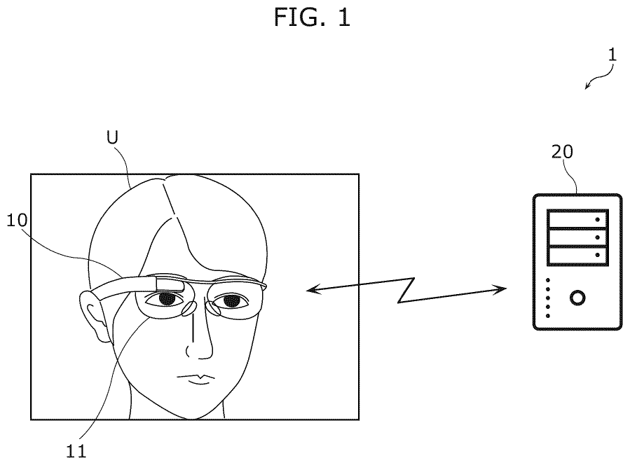

A room layout rearranging system in the present embodiment will be described below with reference to FIGS. 1 to 7.

### [1. Configuration of Room Layout Rearranging System]

The configuration of the room layout rearranging system in the present embodiment will first be described with reference to FIGS. 1 to 3C. FIG. 1 is a diagram showing an outline of room layout rearranging system 1 in the present embodiment.

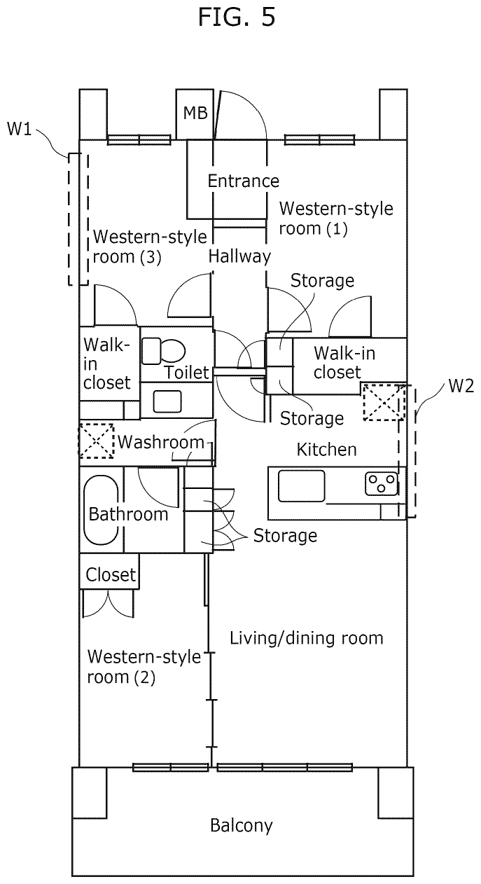

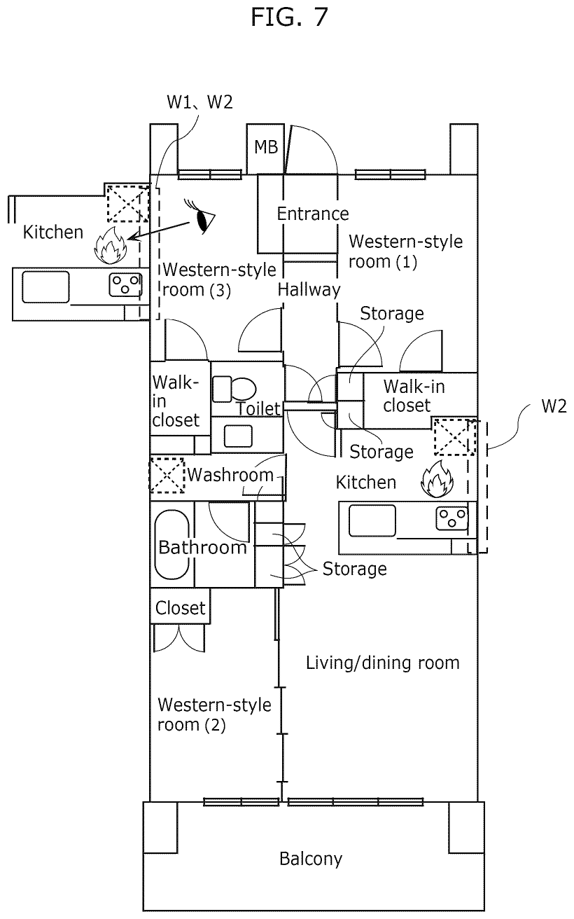

As shown in FIG. 1, room layout rearranging system 1 includes XR device 10 and server device 20. Room layout rearranging system 1 is a video output system (information processing system) for producing, in an augmented reality space provided by augmenting a real space, a display about one space (for example, a second space which will be described later) in a facility (facility in the real space) including a plurality of spaces in the real space (physical space). For example, room layout rearranging system 1 is a system for displaying, in the augmented reality space, a video which is obtained by virtually changing a room layout (see, for example, FIG. 5) in the facility in the real space and corresponds to the virtually changed room layout (see, for example, FIG. 7). In the present specification, virtually changing the room layout is also described as rearranging the room layout (or simply rearranging). The video is a moving image, but may be a still image.

XR device 10 and server device 20 are connected to be able to communicate with each other. An example where room layout rearranging system 1 is used in a house will be described below. User U is assumed to be present in a space (first space) in the house.

XR device 10 is a device for realizing cross reality used by user U, and is, for example, a wearable device worn by user U. XR device is realized by an augmented reality (AR) device such as dedicated goggles. Although in the present embodiment, XR device 10 is realized by a glasses-type display (head-mounted display (HMD)) such as AR glasses, XR device 10 may be realized by smart contact lenses (AR contacts) or the like. Cross reality is a generic term for technologies which merge the real world with the virtual world to enable the perception of things which are not real, and include technologies such as AR.

XR device 10 is an optically transparent device which includes display 11 corresponding to the lens of general glasses, and allows user U to directly and visually recognize an outside scene simultaneously when user U visually recognizes a video displayed on display 11. Display 11 is formed of a translucent material, and is a transmissive display which does not block the view of user U in a state where no video is displayed. XR device 10 virtually rearranges the room layout in the house, and displays a video of a region (second space which will be described later) provided by augmenting the first space on display 11 which is the transmissive display, and allows user U to visually recognize a real object (for example, an object in the first space) through display 11. The rearrangement of the room layout will be described later.

XR device 10 has, for example, a mechanism which allows the video from display 11 to reach the user's eyes directly. In other words, the video is not projected directly onto a building material such as the wall or the ceiling of the first space where the user U is present. In this way, when a person other than user U is present in the first space, the person other than user U does not visually recognize the video which is displayed on display 11 after the rearrangement of the room layout, that is, the video which includes the second space.

Server device 20 is an information processing device for producing, in the augmented reality space, a display about the house including a plurality of spaces in the real space. Server device 20 generates a video when the room layout in the house is virtually rearranged, and outputs the video to XR device 10. Although details will be described later, server device 20 generates a video for coupling a space in a predetermined status among the spaces to the space where user U is present in the augmented reality space, and outputs the video to XR device 10. When a change occurs in the status of a device or a space in the house, server device 20 allows user U to grasp the status of the space without user U moving to the space where the change in the status occurs.

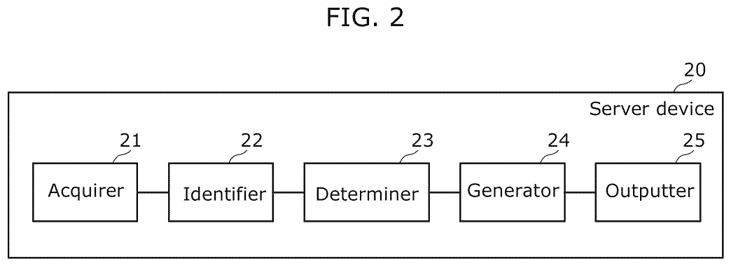

FIG. 2 is a block diagram showing the functional configuration of server device 20 in the present embodiment. Server device 20 is realized, for example, by a personal computer (PC). Server device may be realized by a cloud server.

As shown in FIG. 2, server device 20 includes acquirer 21, identifier 22, determiner 23, generator 24, and outputter 25.

Acquirer 21 acquires information from XR device 10 and sensors provided in spaces (rooms) in the house. Acquirer 21 includes, for example, a communication circuit (communication module). Although examples of the sensor include a temperature sensor, a heat sensor, a smoke sensor, a light/fire sensor, a sound sensor, an odor sensor, a human sensor, a camera, and the like, the sensor is not limited to these examples.

Identifier 22 identifies, in the real space, among the spaces, the first space which is a space in the house where user U is present. The first space is a space where user U is present.

Determiner 23 determines, among the spaces in the house, the first space where user U is present and the space (second space) to which the first space is coupled in the augmented reality space. Determiner 23 determines the second space based on the information acquired by acquirer 21. The second space is a space which is different from the first space, and is currently in a predetermined status.

The predetermined status includes at least one of occurrence of a predetermined anomaly or a predetermined operation status of a device. The predetermined status may include occurrence of an unusual event. The device is an electrical appliance (for example, a home appliance) in the house, and although examples of the device include cooking appliances such as an electromagnetic cooker (for example, an induction cooking heater) and a microwave oven, heating/cooling air conditioners such as an air conditioner, an electric fan and a fan heater, a television set, a refrigerator, a washing machine, and the like, the device is not limited to these examples. The device may be, for example, a device which includes a storage battery (for example, a lithium ion battery) or the like. The device may also be an outlet or the like.

The predetermined anomaly is that sensing data from the sensor (sensor value) exceeds a threshold value, and is, for example, that the sensing data of at least one of heat, smoke, sound, or odor exceeds the threshold value. In other words, the predetermined anomaly includes at least one anomaly of heat, smoke, sound, or odor in the space. For example, the predetermined anomaly may include at least one anomaly of heat, smoke, or odor in the space. Examples of the predetermined anomaly include fire, anomalous heat generation of the device or the like, a predetermined anomalous sound such as an explosion, a predetermined anomalous odor, and the like.

The occurrence of these predetermined anomalies can be identified based on the sensing data from the sensors such as a heat sensor, a smoke sensor, a light/fire sensor, a sound sensor, an odor sensor, and a camera provided in the spaces. Examples of the sensing data include detection temperature data, a smoke presence/absence detection result, sound data, an odor presence/absence detection result, video data, and the like. The video data may be a moving image or a still image.

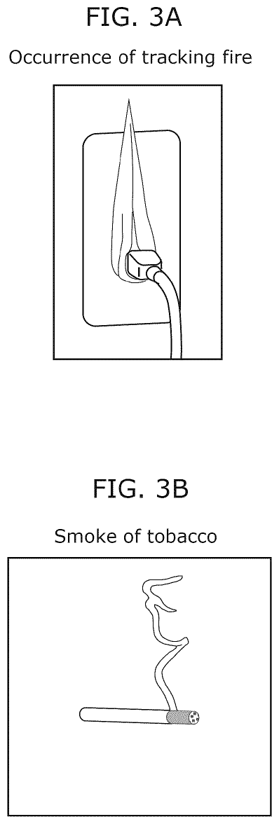

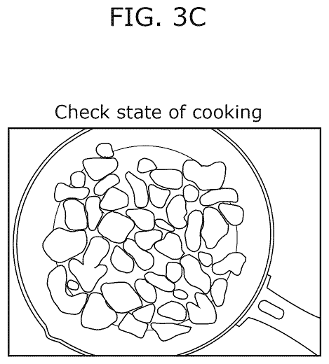

FIG. 3A is a diagram showing a first example of the predetermined status in the present embodiment.

As shown in FIG. 3A, the predetermined anomaly may be a tracking fire.

The unusual event is that the space is in an unusual status, and examples of the unusual event include an event in which a sound having a higher volume than a usual volume is detected, an event in which a person is detected at a time when no one is usually around, an event in which no person is detected at a time when people are usually around, an event in which smoke is detected in a room where people do not usually smoke, and the like.

The occurrence of these unusual events can be identified from the sensing data of a smoke sensor, a sound sensor, a human sensor, a camera, and the like.

FIG. 3B is a diagram showing a second example of the predetermined status in the present embodiment.

As shown in FIG. 3B, the unusual event may be that smoke of tobacco or the like is generated in a space where tobacco is not normally smoked or where smoking is prohibited.

The predetermined operation status includes a change in the operation status of the device, and examples of the predetermined operation status include at least one of completion of an operation performed by the device or occurrence of a failure such as an error in the device. The completion of the operation performed by the device may be, for example, completion of washing and drying in a washing machine, completion of cooking, or completion of heating in a microwave oven. The washing and drying, the cooking, the heating, and the like are examples of the operation.

The occurrence of these predetermined operation statuses can be identified by information about the operation status of the device (for example, information indicating the current status of the device), a heat sensor, a sound sensor, and the like.

The change in the operation status of the device does not include an intermediate stage in a series of operations. For example, when a series of operations in a washing machine are washing and drying, the coupling of the spaces is not performed at a time when the washing is completed, and the coupling of the spaces is performed at a time when the drying is completed.

FIG. 3C is a diagram showing a third example of the predetermined status in the present embodiment.

As shown in FIG. 3C, the change in the operation status of the device may be completion of cooking performed by an induction cooking heater or the like.

With reference back to FIG. 2, generator 24 generates content information for virtually coupling the first space and the second space in the augmented reality space. The content information includes at least video information, and may further include sound information. The content information is an example of presentation information which is presented to user U.

Outputter 25 outputs the content information generated by generator 24 to XR device 10. Outputter 25 includes, for example, a communication circuit (communication module).

As described above, room layout rearranging system 1 does not include a projection device such as a projector.

### [2. Operation of Room Layout Rearranging System]

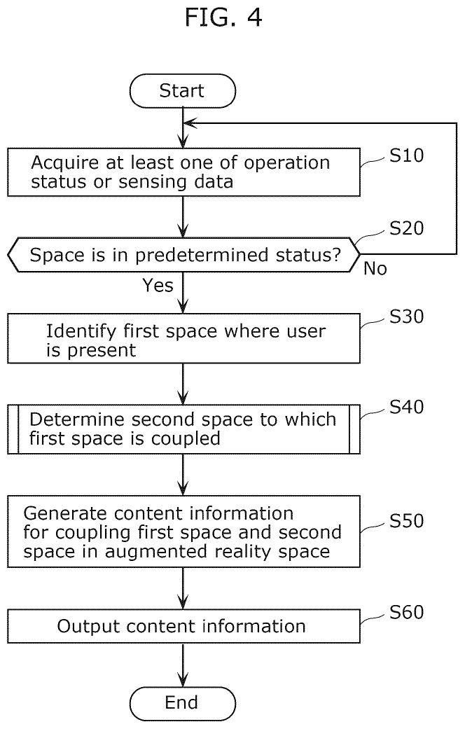

The operation of room layout rearranging system 1 configured as described above will then be described with reference to FIGS. 4 to 7. FIG. 4 is a flowchart showing the operation (video output method) of server device 20 in the present embodiment. Steps shown in FIG. 4 are performed by server device 20. In each of a plurality of spaces, at least one of a device or a sensor is arranged.

As shown in FIG. 4, acquirer 21 acquires at least one of the operation status of the device or sensing data from at least one of the device or the sensor arranged in each of the spaces (S10). At least one of the operation status or the sensing data is an example of status information.

Here, the room layout of the house will be described with reference to FIG. 5. FIG. 5 is a diagram showing the room layout before being rearranged in the present embodiment. The room layout of the house shown in FIG. 5 is the room layout of the house in the real space. The space where user U is present is assumed to be Western-style room (3).

As shown in FIG. 5, the house includes, as the spaces, a living/dining room, a kitchen, Western-style rooms (1) to (3), a toilet, a bathroom, a balcony, a hallway, an entrance, and the like. For example, a walk-in closet may be included in the Western-style rooms. A shed, a garden, and the like in a house site may be included in the spaces.

In each of the spaces, for example, at least one of at least one of the sensors described previously (not shown) or the device is arranged, and at least one of the sensor or the device can communicate with server device 20.

In step S10, at least one of the operation status of the device or the sensing data is acquired from each of the spaces in the house shown in FIG. 5.

Server device 20 may previously acquire and store room layout information as shown in FIG. 5. The room layout information may include position information (for example, a latitude, a longitude, and an altitude) of each of the spaces.

Then, with reference back to FIG. 4, for each of the spaces, determiner 23 determines whether the space is in the predetermined status based on at least one of the operation status of the device or the sensing data of the sensor (S20).

Then, when determiner 23 determines that the space is in the predetermined status (yes in S20), identifier 22 identifies the first space where user U wearing XR device 10 is currently present based on information acquired by acquirer 21 (S30). For example, when acquirer 21 acquires information about the space where user U is currently present, identifier 22 identifies the space indicated by the information as the first space where user U is currently present. For example, when acquirer 21 acquires information which includes the sensing data of each of the spaces, identifier 22 identifies the first space where user U is currently present based on the information. For example, identifier 22 may use image analysis to identify, as the first space, the space where user U wearing XR device 10 is present, or identifier 22 may use sound information obtained by capturing the speech of user U (for example, “I am in the living room”) to determine that user U is currently present in the living/dining room, and thereby identify the living/dining room as the first space. For example, when acquirer 21 acquires the current position information of user U, identifier 22 identifies the first space where user U is currently present based on the position information of each of the spaces included in the position information and the room layout information. The current position information of user U is, for example, information (for example, a latitude, a longitude, and an altitude) which is measured by a position sensor (for example, a global positioning system (GPS) sensor) installed in XR device 10 worn by user U and indicates the current position of user U.

When determiner 23 determines that the space is not in the predetermined status (no in S20), identifier 22 does not perform processing for identifying the first space where user U is currently present, and returns to step S10.

When determiner 23 determines, for each of the spaces, that the space is not in the predetermined status, a determination is made to be no in step S20, and when determiner 23 determines, for at least one of the spaces, that the space is in the predetermined status, a determination is made to be yes in step S20.

Regardless of the determination in step S20, the processing in step S30 may be performed.

Then, determiner 23 determines the second space to which the first space is to be coupled (S40). Determiner 23 determines, based on the status information of each of the spaces, as the second space to which the first space is to be coupled, a space which is currently in the predetermined status among the spaces in the real space. For example, determiner 23 determines, as the second space, among the spaces, a space which is coupled to the first space where user U is currently present in the augmented reality space and is in the predetermined status.

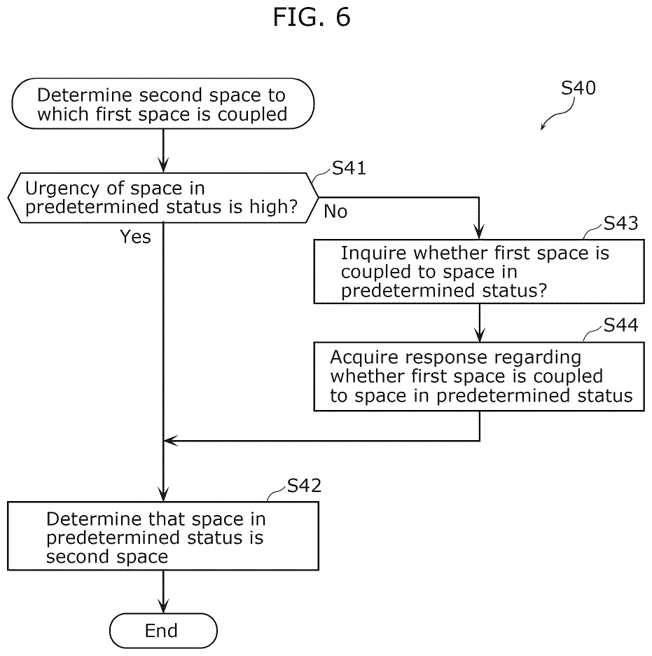

An operation in step S40 will be described with reference to FIG. 6. FIG. 6 is a flowchart showing details of the operation in step S40 (video output method) shown in FIG. 4.

As shown in FIG. 6, determiner 23 determines whether the urgency of the space (for which a determination is made to be yes in S20) in the predetermined status is high (S41). For example, when the predetermined anomaly occurs in the space, determiner 23 determines that the urgency of the space is high, and when an unusual event occurs, and the operation status of the device is changed, determiner 23 determines that the urgency of the space is low. Determiner 23 may make a determination in step S41, for example, based on a table in which the predetermined status is associated with the level of urgency (for example, presence or absence of urgency).

When determiner 23 determines that the urgency of the space is high (yes in S41), determiner 23 determines the space (for which a determination is made to be yes in S41) in the predetermined status as the second space (S42). When determiner 23 determines that the urgency of the space is low (no in S41), determiner 23 inquires of user U whether the first space is coupled to the space (for which a determination is made to be no in S41) in the predetermined status (S43). Determiner 23 outputs, for example, a notification for inquiring whether the first space is coupled to the space to XR device worn by user U or a terminal device (for example, a dedicated remote controller, a smart phone or a tablet terminal) possessed by user U.

Then, when determiner 23 acquires a response from user U regarding whether the first space is coupled to the space in the predetermined status (S44), determiner 23 determines, as the second space, the space in the predetermined status selected or permitted by user U (S42).

Although the example where the space of high urgency is automatically determined as the second space has been described with reference to FIG. 6, the present disclosure is not limited to this example, and the space of low urgency may be automatically determined as the second space. In other words, the determination in step S41 does not need to be performed.

An example where a kitchen is determined as the second space will be described below.

With reference back to FIG. 4, generator 24 generates the content information for coupling the second space to the first space in the augmented reality space (S50). Generator 24 virtually rearranges the room layout in the house such that the second space is present adjacent to the first space, and generates the content information for presenting, to user U, a display about the virtually rearranged room layout. For example, generator 24 generates the content information for presenting, to user U, a video in which the determined second space is coupled to the first space in the augmented reality space via XR device 10 worn by user U.

When a determination is made to be yes in step S41, generator 24 may generate the presentation information including information for forcibly presenting a video to user U via XR device 10 worn by user U. When the presentation information as described above is acquired by XR device 10, for example, the video may be forcibly displayed to user U. For example, regardless of the direction in which user U is looking, the video of the second space may be forcibly displayed by being superimposed on a wall or the like in the real space at which user U is looking.

FIG. 7 is a diagram showing the room layout after being rearranged in the present embodiment. FIG. 7 shows an example where the room layout in the house is virtually rearranged by coupling wall W1 of Western-style room (3) where user U is currently present to wall W2 of the kitchen where the predetermined anomaly occurs. In the kitchen, a tracking fire is assumed to be occurring.

As shown in FIG. 7, generator 24 rearranges the room layout such that walls W1 and W2 are superimposed on each other (for example, walls W1 and W2 have the same coordinates). Generator 24 virtually rearranges the room layout by adding the kitchen to the left of Western-style room (3).

For example, when user U looks toward wall W1 in the real space, generator 24 generates the content information such that a video (digital information) of the inside of the kitchen viewed from the side of wall W2 is displayed by being superimposed on wall W1. The content information is information for augmenting the first space by virtually coupling the second space to the first space in the real space. The content information is also said to include information for superimposing, when user U looks at the side of the rearranged second space in the real space, a video obtained by capturing the second space on the first space via XR device 10 and presenting the video superimposed on the first space.

Generator 24 generates the content information based on the video obtained by capturing the second space with a camera provided in the second space. In this way, it is possible to realize the video where the kitchen is located on the left of Western-style room (3) in the augmented reality space.

For example, generator 24 may generate the content information in which one of a plurality of walls in the first space is coupled to one of a plurality of walls in the second space in the augmented reality space. For example, generator 24 may generate the content information in which the wall of the largest area (for example, wall W1) among a plurality of walls in the first space is coupled to the wall of the largest area (for example, wall W2) among a plurality of walls in the second space in the augmented reality space. For example, the content information as described above includes information for superimposing a video obtained by capturing the second space on wall W1 of the largest area in the first space in the real space via XR device 10 and presenting the video superimposed on wall W1. In this case, the content information may be generated such that for example, when user U looks at wall W1 via XR device 10, wall W1 is not seen. For example, the content information may be a video in which Western-style room (3) is coupled to the kitchen (no wall is present between Western-style room (3) and the kitchen).

User U may be caused to select how the second space is coupled to the first space, that is, to which one of building materials in the first space the second space is coupled and in which direction the second space is coupled. Generator 24 may couple the second space to the first space based on an instruction from user U.

Generator 24 may include information indicating the status of the second space in the content information. For example, information indicating in which part of the kitchen an anomaly occurs, what type of anomaly (such as temperature, smoke, or fire) occurs and the like may be displayed by being superimposed on a video of the kitchen viewed by user U via XR device 10. The video of the kitchen is a video which shows the part of the kitchen where the anomaly occurs. Information indicating whether user U should rush to the kitchen to check may be superimposed on the video of the kitchen. For example, generator 24 may use a table in which details of an anomaly (such as temperature, smoke, or fire) are associated with information indicating whether user U should rush to check, and thereby generate the content information in which the information indicating whether user U should rush to check is superimposed. Information indicating measures to be taken by user U may be superimposed on the video of the kitchen. For example, generator 24 may use a table in which details of an anomaly (such as temperature, smoke, or fire) are associated with information indicating measures to be taken, and thereby generate the content information in which the information indicating measures to be taken is superimposed. The measures to be taken may be calling a fire department, performing firefighting activities, running away, or the like.

Generator 24 may include information indicating to which space the first space is coupled in the content information. In other words, the video of the kitchen and information indicating that the first space is coupled to the kitchen may be displayed by being superimposed on the video viewed by user U via XR device 10.

Then, with reference back to FIG. 4, outputter 25 outputs the content information generated by generator 24 to XR device 10 (S60).

Display 11 of XR device 10 displays the content information from server device 20. For example, when user U looks at wall W1, display 11 displays a video such that the video of the kitchen is displayed on wall W1. Display 11 superimposes, on wall W1 in the real world which can be directly seen with the naked eye, a video of the second space which is not actually visible (is not present in the first space), and displays the video of the second space superimposed on wall W1. The video of the kitchen displayed on display 11 is, for example, a video which displays the state of the kitchen in real time.

In this way, user U can check the state of the space in the predetermined status in the augmented reality space without moving to the space. For example, when a tracking fire occurs, user U can find the occurrence of the tracking fire in the augmented reality space, and thus user U can quickly take measures such as initial fire extinguishing. For example, when certain user U smokes tobacco, and thus smoke is detected, user U can find, in the augmented reality space, that the certain user is smoking tobacco (that is, that the smoke is not caused by a fire or the like), with the result that user U does not need to move to the space where the certain user is present to check. For example, when the smoke is detected while user U is performing an operation or the like, user U can find that the smoke is not problematic without moving to the space where the certain user is present, with the result that user U can continue to perform the operation or the like.

### OTHER EMBODIMENTS

Although the room layout rearranging system and the like in one or a plurality of aspects have been described above based on the embodiment, the present disclosure is not limited to the embodiment. Embodiments obtained by performing various types of variations conceived by those skilled in the art on the present embodiment and embodiments formed by combining constituent elements in different embodiments may be included in the present disclosure.

For example, although in the above embodiment, the example where the facility is the house has been described, the facility may be a building for which room layout information can be acquired and examples thereof may include a school, a hospital, a nursing home, an office building, and the like.

Although in the above embodiment, the example where one second space is determined has been described, the present disclosure is not limited to the example, and two or more second spaces may be determined. When two or more second spaces are determined, for example, server device 20 may couple a different second space to each of a plurality of walls in the first space. When two or more second spaces are determined, for example, server device 20 may display the two or more second spaces in a time-division manner. For example, server device 20 may switch the second space coupled to the first space at regular intervals (for example, every few seconds). As described above, room layout rearranging system 1 may be configured such that the room layout (rearranged room layout) in the facility in the augmented reality space can be freely changed spatially or chronologically.

Although in the above embodiment, the example where XR device 10 is an optically transparent device has been described, the present disclosure is not limited to the example. XR device 10 may be, for example, a non-transparent binocular type HMD display. In this case, XR device 10 includes a camera, and superimposes the video data of the second space on the video data of the first space captured with the camera to produce a display. As described above, superimposing the video data of the second space (digital information based on the second space) on the video data of the first space (digital information based on the first space) to produce a display is also included in coupling the second space to the first space in the augmented reality space.

Although in the above embodiment, the example where the walls of the first space and the second space are coupled has been described, the present disclosure is not limited to the example, and for example, doors, windows, or the like may be coupled. When a description will be given using doors as an example, for example, generator 24 may generate the content information for coupling the door of the first space and the door of the second space in the augmented reality space. When user U looks toward the door of the first space in the real space, generator 24 may generate the content information such that a video (digital information) of the inside of the second space viewed from the side of the door of the second space is displayed by being superimposed on the door of the first space. The content information as described above includes information for superimposing a video obtained by capturing the second space on the door of the first space in the real space via XR device 10 and presenting the video superimposed on the door of the first space.

In the embodiment described above, communication between XR device 10 and server device 20 is, for example, performed wirelessly. Although the communication between XR device 10 and server device 20 is, for example, wireless communication using a wide area communication network such as the Internet, the communication may be short-distance wireless communication such as ZigBee (registered trademark), Bluetooth (registered trademark), or wireless local area network (LAN). The communication between XR device 10 and server device 20 may be, for example, performed in a wired manner.

In the embodiment described above, constituent elements may be formed by dedicated hardware or may be realized by executing software programs suitable for the constituent elements. A program executor such as a CPU or a processor may read and execute software programs recorded in a recording medium such as a hard disk or a semiconductor memory to realize the constituent elements.

The order in which the steps in the flowchart are performed is used as an example for specifically describing the present disclosure, and an order other than the order described above may be adopted. A part pf the steps described above may be performed at the same time (in parallel) with another step, or does not need to be performed.

The division of functional blocks in the block diagram is an example, and a plurality of functional blocks may be realized as one functional block, one functional block may be divided into a plurality of blocks, or a part of functions may be transferred to another functional block. The functions of a plurality of functional blocks which have similar functions may be processed by a single hardware or software unit in parallel or in a time division manner.

Server device 20 in the embodiment described above may be realized as a single device, or may be realized by a plurality of devices. When server device 20 is realized by a plurality of devices, the distribution of constituent elements included in server device 20 to the devices is not limited. When server device 20 is realized by a plurality of devices, a method for communication between the devices is not particularly limited, and may be a method performed by wireless communication or wired communication. Wireless communication and wired communication may be combined for communication between the devices. At least a part of the functions of server device 20 may be realized by XR device 10.

The constituent elements described in the above embodiment may be realized as software or may be typically realized as an LSI circuit which is an integrated circuit. These constituent elements may be individually integrated into one chip, or integration into one chip may be achieved to include a part or all of the constituent elements. Although here, the integrated circuit is an LSI circuit, the integrated circuit may be called an IC, a system LSI circuit, a super LSI circuit, or an ultra LSI circuit depending on the degree of integration. A method for forming the integrated circuit is not limited to LSI, and may be realized by a dedicated circuit (general-purpose circuit which executes a dedicated program) or a general-purpose processor. A field programmable gate array (FPGA) which can be programmed after the manufacturing of an LSI circuit or a reconfigurable processor which can reconfigure connections or settings of circuit cells inside an LSI circuit may be utilized. Furthermore, if an integrated circuit technology which replaces LSI emerges due to an advance in semiconductor technology or another derivative technology, the constituent elements may naturally be integrated using the technology.

The system LSI circuit is a super-multifunctional LSI circuit which is manufactured by integrating a plurality of processors on one chip, and is specifically a computer system which includes a microprocessor, a read only memory (ROM), a random access memory (RAM), and the like. In the ROM, computer programs are stored. The microprocessor is operated according to the computer programs, and thus the system LSI circuit achieves its functions.

One aspect of the present disclosure may be a computer program which causes a computer to execute the characteristic steps included in the video output method shown in either of FIGS. 4 and 6.

For example, the program may be a program which is executed by a computer. One aspect of the present disclosure may be a non-transitory computer-readable recording medium in which such a program is recorded. For example, such a program may be recorded in a recording medium to be distributed or circulated. For example, the distributed program is installed in a device having another processor, the program is executed by the processor, and thus the device can perform the processing described previously.

### (Additional Notes)

The following techniques are disclosed by the embodiments and the like described above.

### (Technique 1)

A video output method for producing, in an augmented reality space provided by augmenting a real space, a display about one space in a facility including a plurality of spaces in the real space, the video output method including: acquiring status information indicating a status of each of the plurality of spaces; identifying, among the plurality of spaces in the real space, a first space in which a user is currently present; determining, based on the status information of each of the plurality of spaces, as a second space to which the first space is to be coupled, a space that is currently in a predetermined status among the plurality of spaces in the real space; and outputting presentation information for presenting, to the user, via a cross reality (XR) device worn by the user, a video in which the second space determined is coupled to the first space in the augmented reality space.

### (Technique 2)

The video output method described in technique 1 where the status information includes information indicating an operation status of a device provided in a space, and the predetermined status includes a predetermined operation status of the device.

### (Technique 3)

The video output method described in technique 2 where the predetermined operation status includes completion of an operation performed by the device.

### (Technique 4)

The video output method described in technique 2 or 3 where the predetermined operation status includes occurrence of an anomaly in the device.

### (Technique 5)

The video output method described in any one of techniques 1 to 4, further including: inquiring of the user whether to couple the second space to the first space in the augmented reality space, where the presentation information is output when an instruction to couple the second space to the first space is acquired from the user.

### (Technique 6)

The video output method described in any one of techniques 1 to 5 where the status information includes sensing data of a sensor provided in a space, whether a predetermined anomaly occurs in the space is determined based on the sensing data, and the predetermined status includes occurrence of the predetermined anomaly in the space.

### (Technique 7)

The video output method described in technique 6 where the predetermined anomaly includes at least one anomaly of heat, smoke, sound, or odor in the space.

### (Technique 8)

The video output method described in technique 6 or 7 where the presentation information includes information for forcibly presenting the video to the user via the XR device worn by the user.

### (Technique 9)

The video output method described in any one of techniques 1 to 8, further including: virtually rearranging the second space determined adjacent to the first space in room layout information indicating a room layout of the plurality of spaces in the facility, where the presentation information includes information for superimposing a video obtained by capturing the second space on the first space and presenting the video superimposed on the first space via the XR device when the user views, in the real space, a side of the second space virtually rearranged.

### (Technique 10)

A video output system for producing, in an augmented reality space provided by augmenting a real space, a display about one space in a facility including a plurality of spaces in the real space, the video output system including: an acquirer that acquires status information indicating a status of each of the plurality of spaces; an identifier that identifies, among the plurality of spaces in the real space, a first space in which a user is currently present; a determiner that determines, based on the status information of each of the plurality of spaces, as a second space to which the first space is to be coupled, a space that is currently in a predetermined status among the plurality of spaces in the real space; and an outputter that outputs presentation information for presenting, to the user, via a cross reality (XR) device worn by the user, a video in which the second space determined is coupled to the first space in the augmented reality space.

### (Technique 11)

A non-transitory computer-readable recording medium having recorded thereon a program for causing a computer to execute the video output method described in any one of techniques 1 to 9.

### INDUSTRIAL APPLICABILITY

The present disclosure is useful for a system using an XR device and the like.

1. A video output method for producing, in an augmented reality space provided by augmenting a real space, a display about one space in a facility including a plurality of spaces in the real space, the video output method comprising:
acquiring status information indicating a status of each of the plurality of spaces;
identifying, among the plurality of spaces in the real space, a first space in which a user is currently present;
determining, based on the status information of each of the plurality of spaces, as a second space to which the first space is to be coupled, a space that is currently in a predetermined status among the plurality of spaces in the real space; and
outputting presentation information for presenting, to the user, via a cross reality (XR) device worn by the user, a video in which the second space determined is coupled to the first space in the augmented reality space.

2. The video output method according to claim 1,
wherein the status information includes information indicating an operation status of a device provided in a space, and
the predetermined status includes a predetermined operation status of the device.

3. The video output method according to claim 2,
wherein the predetermined operation status includes completion of an operation performed by the device.

4. The video output method according to claim 2,
wherein the predetermined operation status includes occurrence of an anomaly in the device.

5. The video output method according to claim 2, further comprising:
inquiring of the user whether to couple the second space to the first space in the augmented reality space,
wherein the presentation information is output when an instruction to couple the second space to the first space is acquired from the user.

6. The video output method according to claim 1,
wherein the status information includes sensing data of a sensor provided in a space,
whether a predetermined anomaly occurs in the space is determined based on the sensing data, and
the predetermined status includes occurrence of the predetermined anomaly in the space.

7. The video output method according to claim 6,
wherein the predetermined anomaly includes at least one anomaly of heat, smoke, sound, or odor in the space.

8. The video output method according to claim 6,
wherein the presentation information includes information for forcibly presenting the video to the user via the XR device worn by the user.

9. The video output method according to claim 1, further comprising:
virtually rearranging the second space determined adjacent to the first space in room layout information indicating a room layout of the plurality of spaces in the facility,
wherein the presentation information includes information for superimposing a video obtained by capturing the second space on the first space and presenting the video superimposed on the first space via the XR device when the user views, in the real space, a side of the second space virtually rearranged.

10. A video output system for producing, in an augmented reality space provided by augmenting a real space, a display about one space in a facility including a plurality of spaces in the real space, the video output system comprising:
an acquirer that acquires status information indicating a status of each of the plurality of spaces;
an identifier that identifies, among the plurality of spaces in the real space, a first space in which a user is currently present;
a determiner that determines, based on the status information of each of the plurality of spaces, as a second space to which the first space is to be coupled, a space that is currently in a predetermined status among the plurality of spaces in the real space; and
an outputter that outputs presentation information for presenting, to the user, via a cross reality (XR) device worn by the user, a video in which the second space determined is coupled to the first space in the augmented reality space.

11. A non-transitory computer-readable recording medium having recorded thereon a program for causing a computer to execute the video output method according to claim 1.
